(19) United States
(12) Patent Application Publication
(10) Pub. No.: US 2003/0061289 A1
(43) Pub. Date: Mar. 27, 2003

(54) Apparatus and method of filtering out e-mail addresses from an e-mail distribution list

(75) Inventors: David Neal Clissold, Austin, TX (US); Susann Marie Keohane, Austin, TX (US); Johnny Meng-Han Shieh, Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 09/961,992

(22) Filed: Sep. 24, 2001

(51) Int. Cl. G06F 15/16

(52) U.S. Cl. 709/206; 709/229; 709/225

(57) ABSTRACT

A method and apparatus for excluding recipients from a list of recipients are provided. The list may be a distribution list or may manually be entered in any or all of an addressee box, a carbon copy box and a blind copy box of a GUI of an e-mail software tool. The present invention uses an added box (i.e., an exclusion box) to exclude recipients from the list. Before actually sending a message to a list of recipients, the invention checks to see whether any one of the recipients should not receive the message. If a recipient is not to receive the message (indicated by an entry in the exclusion box), the invention extricates the address of the recipient from the list and then forwards the message to the rest of the recipients.

### BACKGROUND OF THE INVENTION

1. Technical Field

The present invention is directed to a method and apparatus for managing electronic mail distribution lists. More specifically, the present invention is directed to an apparatus and method of filtering out e-mail addresses from an electronic mail distribution list.

2. Description of Related Art

Electronic mail or e-mail is the transmission of messages over communications networks. The messages can be notes entered using a keyboard or electronic files stored on disks. Most e-mail systems include a rudimentary text editor for composing messages, but many allow a user to edit messages using any editor. After composing a message, the message is sent to a recipient by specifying the recipient's e-mail address in an address box. The message can also be sent or broadcasted to several recipients at once if several recipients' e-mail addresses are specified in the box.

To make it easy on a user who consistently sends messages to a particular group of recipients, most e-mail software tools allow the user to enter the address of each recipient in the group into a file called a distribution list. When the user needs to send a message to the group of recipients, the user needs only enter the name of the file in the address box and the message is sent to all the recipients in the group.

The distribution list is a rather convenient tool so long as the user is sending the message to all the recipients in the group. If however, the user ever wants to exclude one or two recipients from receiving a message, the user may not use the distribution list. In this case, the user has to either make a new distribution list excluding the one or two recipients or enter in the address box the email addresses of all the recipients to whom the user intends to send the message. Depending on the number of recipients to receive the message, it can be a very tedious task. Furthermore, entering e-mail addresses of groups of recipients in the address box defeats the purpose of a distribution list.

Thus, what is needed is an apparatus and method of filtering out e-mail addresses of recipients to whom a user does not intend to send a message from an e-mail distribution list.

### SUMMARY OF THE INVENTION

The present invention provides a method and apparatus for excluding recipients from a list of e-mail recipients. The list may be a distribution list or may manually be entered in any or all of an addressee box, a carbon copy box and a blind copy box of a GUI of an e-mail software tool. The present invention uses an added exclusion box. Recipients whose e-mail addresses are entered in the exclusion box will not receive the e-mail message.

According to the invention, the addresses of the recipients are in a distribution list file. When a recipient in the list should not receive an e-mail message, instead of making a new e-mail distribution list excluding the recipient or manually entering the e-mail addresses of the recipients to receive the message in any or all of the addressee, carbon copy and blind copy boxes, the name of the distribution list may simply be entered in the proper box, then, the name of the recipient that should not receive the message entered in the exclusion box. Before the message is actually forwarded to the recipients, the distribution list file is opened and the address of the recipient in the exclusion box is taken out of the list. After taking out the address of the recipient in the exclusion box, the message is forwarded.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 is a graphical user interface (GUI) of an existing e-mail software tool.

FIG. 5 is a GUI used by the present invention.

FIG. 6 is a flow diagram of a method used by the invention to exclude recipients from a distribution list.

FIG. 7 is a flow diagram of another method used by the invention to exclude recipients from receiving an e-mail message.

### DETAILED DESCRIPTION OF THE PREFERRED EMBODIMENT

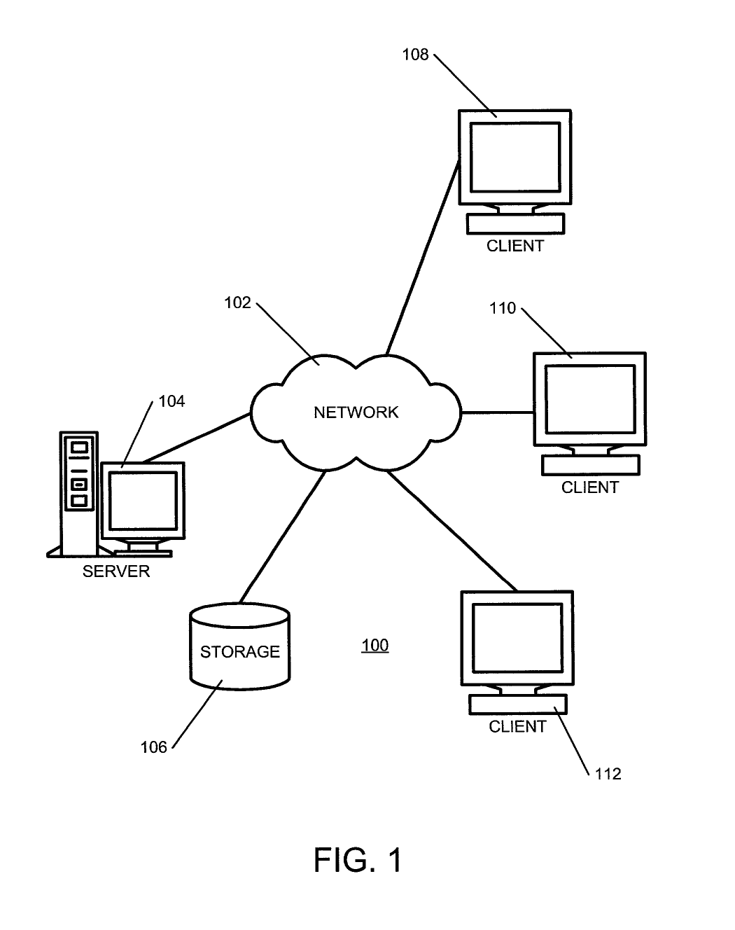

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

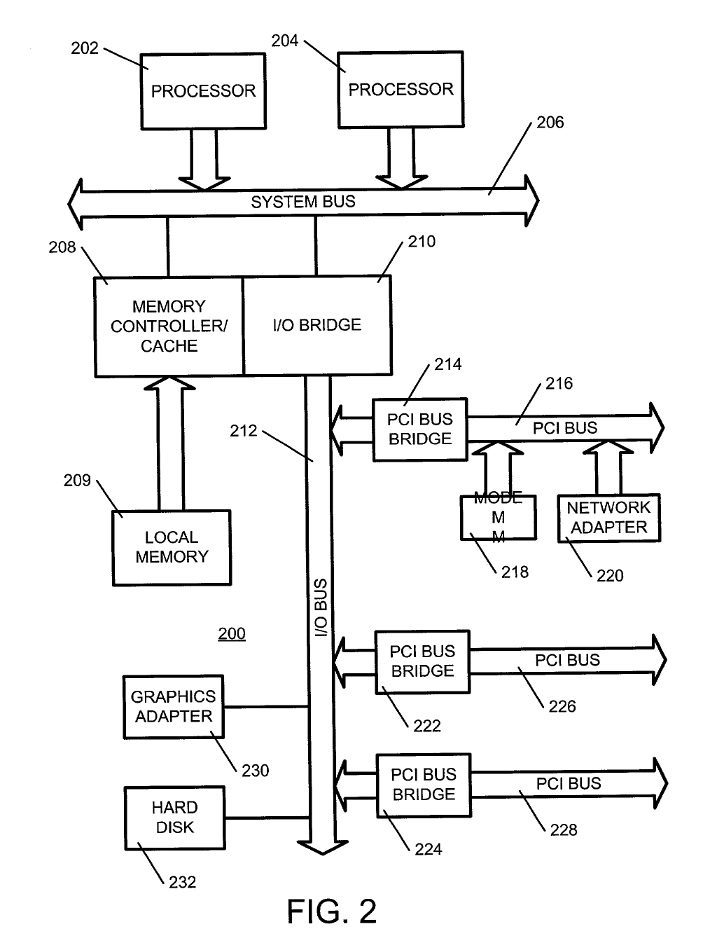

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

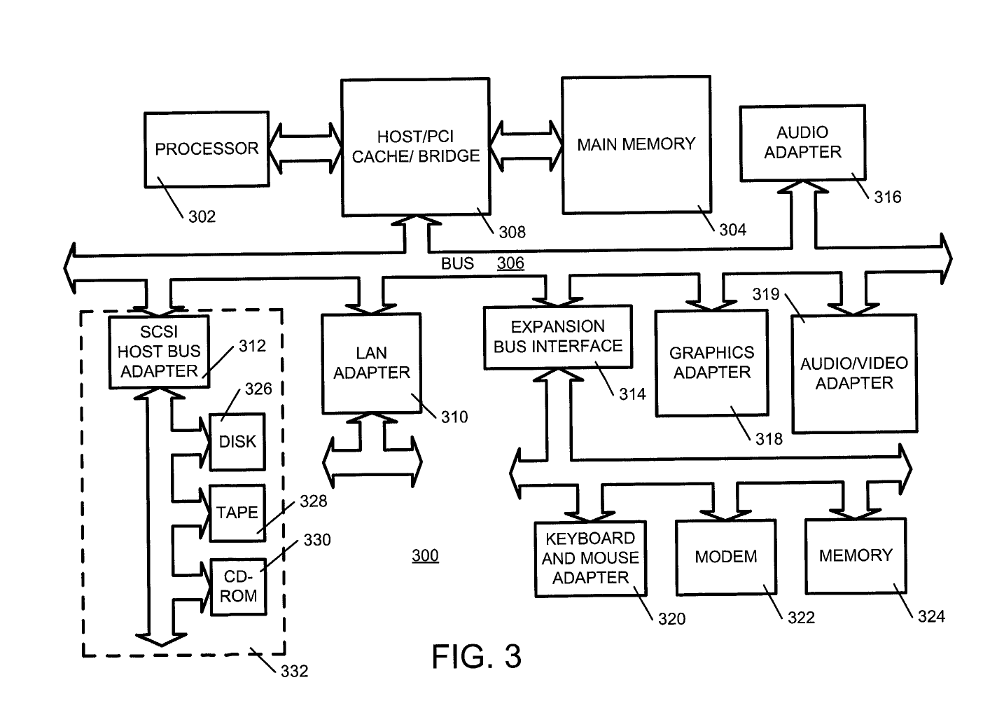

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus and method of filtering out e-mail addresses of recipients from an email distribution list. The invention may be local to client systems 108, 110 and 112 of FIG. 1 or to the server 104 or to both the server 104 and clients 108, 110 and 112. Consequently, the present invention may reside on any data storage medium (i.e., floppy disk, compact disk, hard disk, ROM, RAM, etc.) used by a computer system.

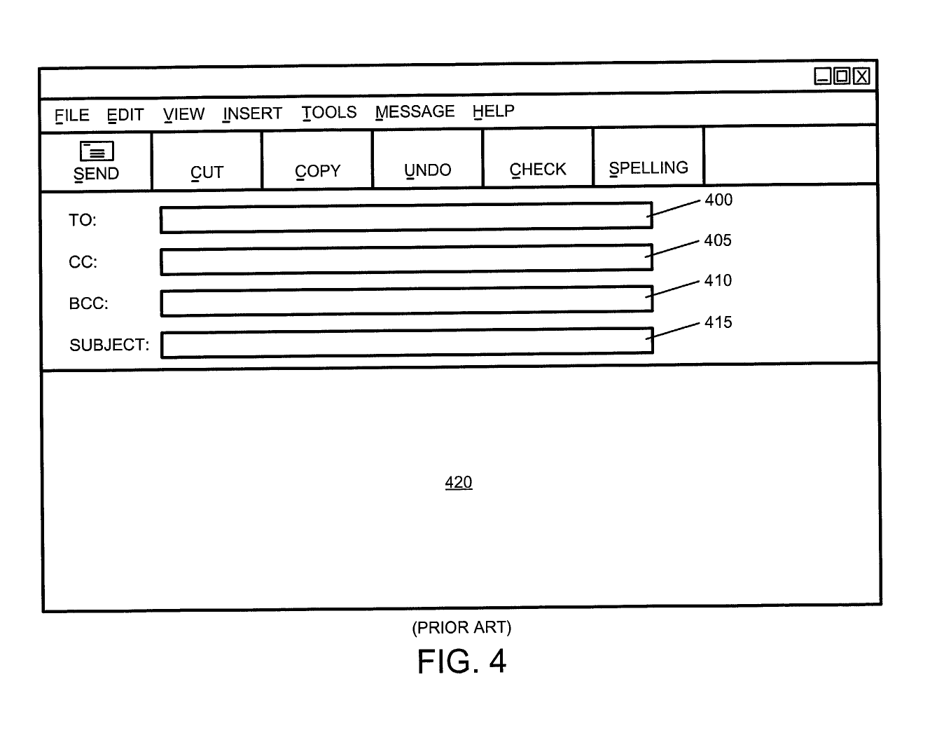

FIG. 4 is a graphical user interface (GUI) of an existing e-mail software tool. In this figure, only the items that are of importance to the invention are given a reference numeral. The GUI has address box 400, carbon copy box 405, blind copy box 410, subject matter box 415 and message or text area 420. E-mail addresses of intended recipients are entered into address box 400. Carbon copy box 405 is used to enter the e-mail addresses of recipients who need to know about what is said in the message; but, the message is not necessarily addressed to them. Blind copy box 410 is used to enter the e-mail addresses of recipients that the user wishes to know about the content of the message, but as with the recipients in address box 405, the message is not addressed to them. Recipients whose e-mail addresses are entered in address box 400 and carbon copy box 405 are aware that they all receive the message. However, they are not aware that the recipients whose e-mail addresses are entered in blind copy box 410 receive the message also. But, the recipients whose e-mail addresses are entered in blind copy box 410 are aware that recipients whose e-mail addresses are entered in address box 400 and carbon copy 405 do receive the message. The subject matter of the message is entered in subject box 415 and the actual message is entered in text area 420.

As an example, suppose that a user often sends e-mail messages to a group of recipients whose e-mail addresses are: a@ibm.com, b@ibm.com . . . z@ibm.com. The user may enter these e-mail addresses in a distribution list. Each time, the user needs to send an e-mail message to the group, the name of the distribution list may be entered in any one of address box 400, carbon copy box 405 and blind copy box 410 and the e-mail message will be sent to all the recipients whose e-mail addresses are in the distribution list.

Presently, when a distribution list file is used, the list and the message are sent to a mail server. When the mail server receives the e-mail distribution list file, it opens up the file and extricates the e-mail addresses. The message is then sent to the recipients using the extricated e-mail addresses. However, the invention may be implemented such that the computer system user by the user opens up the distribution list file and extricates the e-mail addresses found therein and sends the list of addresses to the server.

In any case, if the user wishes not to send the message to one of the recipients, say for instance b@ibm.com, the distribution list may not be used. For example, suppose that the user is organizing a surprise party for Mr. B, the user will not want Mr. B to receive the message. According to present e-mail systems, the user needs to type in the e-mail addresses of all intended recipients (i.e., 25 e-mail addresses) in the e-mail address box 400, carbon copy box 405 or blind copy box 410. Alternatively, the user may have to enter the e-mail addresses of the 25 recipients in a new distribution list in order to exclude Mr. B's e-mail address (i.e., b@ibm.com in this example). The present invention, however, allows the existing distribution list to be used without any modifications.

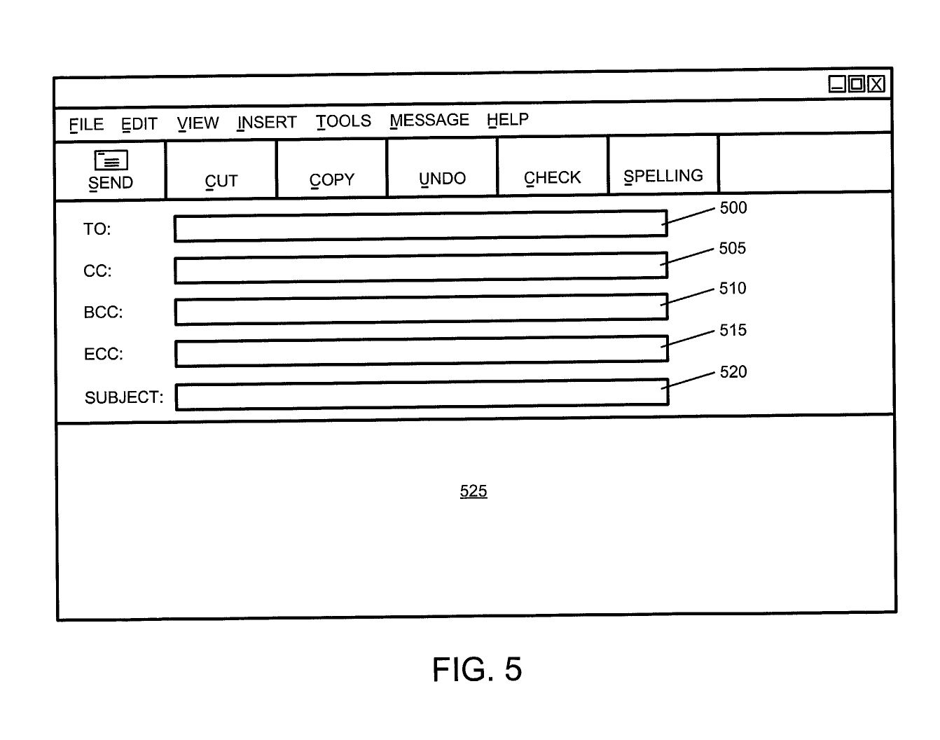

The invention uses an added box, an exclusion box, in the GUI to instruct either the mail server or the computer system in use by the user not to send messages to certain email addresses in the e-mail distribution list. FIG. 5 is a GUI used by the present invention that includes such box. Shown in the GUI are address box 500, carbon copy box 505, blind copy box 510 and exclusion box 515. Address box 500, carbon copy box 505 and blind copy box 510 perform the same functions as address box 400, carbon copy 405 and blind copy box 410 in FIG. 4. Exclusion box 515 is the “exclude from the distribution list” box. Any recipients whose e-mail addresses are entered in exclusion box 515 will not be sent the message. Subject matter box 520 and text area 525 also perform the same functions as subject matter box 415 and text area 420, respectively.

In operation, when the mail server receives the message and the distribution list, it opens up the distribution list to get the e-mail addresses. E-mail addresses entered in exclusion box 515 will be taken off the list of recipients to whom the message is to be sent before the message is sent out. If for some reasons, an e-mail address entered in exclusion box 515 is not in the distribution list, an error message will not be generated since the message will not be sent to that e-mail address just as requested. Note that the server does not modify the file at all. That is, the actual content of the file remains intact and the user may use the distribution list anytime thereafter a message is to be sent to all the recipients in the group.

Furthermore, note that a distribution list may be used in exclusion box 515 also. In this case, the list will be expanded or the file opened and any e-mail addresses found therein will be taken off e-mail addresses or list of email addresses found in any of address box 500, carbon copy box 505 and blind copy box 510.

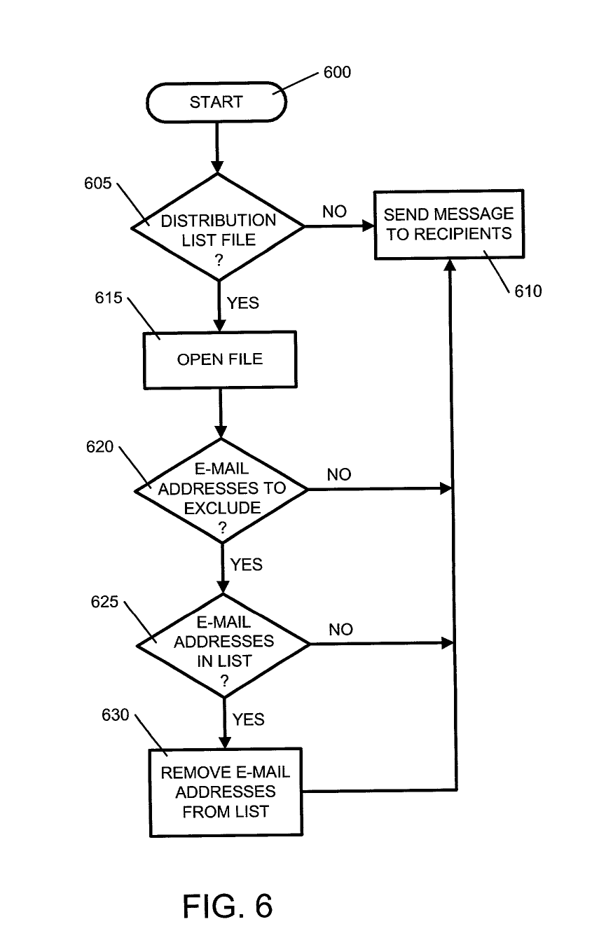

FIG. 6 is a flow diagram of a method used by the invention. When an e-mail message is sent to the mail server the process starts (step 600). A check is made as to whether there is a distribution file in any of boxes 500, 505, and 510. If there is not a distribution list file, the message is sent to the recipients entered in address box 500, carbon copy box 505 and blind copy box 510 (steps 605 and 610). If there is a distribution list file in any of address box 500, carbon copy box 505 and blind copy box 510, the file is opened and the e-mail addresses in the file extricated (steps 605 and 615). Next, a check is made as to whether there exists e-mail addresses and/or a distribution list in address box 515. If there exists a distribution list in exclusion box 515, the file is opened and the e-mail addresses extricated. If there are e-mail addresses to exclude, the e-mail addresses are removed from any file in address box 500, carbon copy box 505 and blind copy box 510 before sending the file to the recipients (steps 620, 625 and 630 and 610).

The invention is described in terms of a distribution list, however, there need not be a distribution list. So long as there is an entry in exclusion box 515 the invention will work. That is, a comparison is always made between email addresses in address box 500, carbon copy box 505 and blind copy box 510 and e-mail addresses in exclusion box 515. If an address in exclusion box 515 is also in address box 500, carbon copy box 505 or blind copy box 510, the recipient of that address will not receive the message. This is particularly helpful when replying to an e-mail message that may originally have a lot of recipients. The user may not care who receives the reply, so long as particular recipients that may or may not be in the original message do not receive the reply. Therefore, instead of searching the list of original recipients for those particular recipients, the user may simply enter the e-mail addresses of those recipients in exclusion box 515 and asserts the “reply to all” button. If those recipients were in the original message, they will not receive the user's reply. As mentioned before, if the recipients to be excluded were not in the original message, an error will not be generated for, as requested, they will not receive the reply.

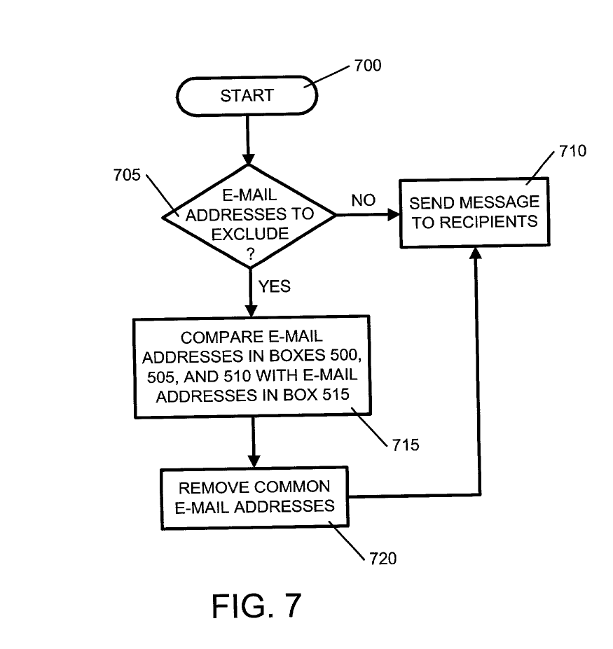

FIG. 7 is a flow diagram of another method used by the invention to exclude recipients from receiving an e-mail message. Again the process starts as soon as an e-mail message is sent to the mail server (step 700). Upon receiving the message and recipients to whom the message is to be sent, the mail server checks to see whether an e-mail address or e-mail addresses need to be excluded. If so, the mail server makes a comparison between each e-mail address in exclusion box 515 with e-mail addresses in address box 500, carbon copy box 505 and blind copy box 510. Any e-mail address common to address box 500, carbon copy box 505 or blind copy box 510 and exclusion box 515 is excluded and the message is sent to the rest of recipients (steps 705, 715, 720 and 710). If no e-mail addresses are to be excluded, the message is simply sent to the recipients.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of sending e-mail message to recipients, each recipient having an e-mail address, the message including the e-mail addresses of the recipients, the method comprising the steps of:
determining whether at least one recipient is to be excluded from receiving the message;
automatically removing the e-mail address of the at least one recipient, if the at least one recipient is to be excluded; and
sending the message to the recipients not excluded.

2. The method of claim 1 wherein the e-mail addresses of the recipients are in a distribution list file.

3. The method of claim 2 wherein the e-mail address of the at least one recipient is entered in an exclusion address box.

4. The method of claim 3 wherein the e-mail addresses of the recipients are entered in a copy box.

5. The method of claim 4 wherein the e-mail addresses of the recipients are entered in a blind copy box.

6. A computer program product stored in computer readable medium for sending e-mail message to recipients, each recipient having an e-mail address, the message including the e-mail addresses of the recipients, the computer program product comprising:
code means for determining whether at least one recipient is to be excluded from receiving the message;
code means for automatically removing the e-mail address of the at least one recipient, if the at least one recipient is to be excluded; and
code means for sending the message to the recipients not excluded.

7. The computer program product of claim 6 wherein the email addresses of the recipients are in a distribution list file.

8. The computer program product of claim 7 wherein the email address of the at least one recipient is entered in an exclusion address box.

9. The computer program product of claim 8 wherein the email addresses of the recipients are entered in a copy box.

10. The computer program product of claim 9 wherein the email addresses of the recipients are entered in a blind copy box.

11. An apparatus for sending e-mail message to recipients, each recipient having an e-mail address, the message including the e-mail addresses of the recipients, the apparatus comprising:
means for determining whether at least one recipient is to be excluded from receiving the message;
means for automatically removing the e-mail address of the at least one recipient, if the at least one recipient is to be excluded; and
means for sending the message to the recipients not excluded.

12. The apparatus of claim 11 wherein the e-mail addresses of the recipients are in a distribution list file.

13. The apparatus of claim 12 wherein the e-mail address of the at least one recipient is entered in an exclusion address box.

14. The apparatus of claim 13 wherein the e-mail addresses of the recipients are entered in a copy box.

15. The apparatus of claim 14 wherein the e-mail addresses of the recipients are entered in a blind copy box.

16. A computer system for sending e-mail message to recipients, each recipient having an e-mail address, the message including the e-mail addresses of the recipients, the computer system comprising:
a storage device for storing data code;
a processor for processing said code data, said data code for determining whether at least one recipient is to be excluded from receiving the message, for automatically removing the e-mail address of the at least one recipient, if the at least one recipient is to be excluded, and for sending the message to the recipients not excluded.

17. The computer system of claim 16 wherein the e-mail addresses of the recipients are in a distribution list file.

18. The computer system of claim 17 wherein the e-mail address of the at least one recipient is entered in an exclusion address box.

19. The computer system of claim 18 wherein the e-mail addresses of the recipients are entered in a copy box.

20. The computer system of claim 19 wherein the e-mail addresses of the recipients are entered in a blind copy box.
